(19) United States
(12) Patent Application Publication
(10) Pub. No.: US 2021/0039612 A1
(43) Pub. Date: Feb. 11, 2021

(54) BRAKING SYSTEM FOR A VEHICLE

(71) Applicant: NIO USA, Inc., San Jose, CA (US)

(72) Inventor: Jorge Marquez Sanchez, Cupertino, CA (US)

(21) Appl. No.: 16/532,102

(22) Filed: Aug. 5, 2019

(51) Int. Cl. B60T 7/04; B60T 8/18; B60T 11/16; B60T 8/40; B60T 7/06; B60T 8/17; B60T 8/32; B60T 13/74

(52) U.S. Cl. CPC B60T 7/042; B60T 8/1837; B60T 11/16; B60T 8/409; B60T 2250/02; B60T 8/1701; B60T 8/326; B60T 13/745; B60T 2270/82; B60T 7/06

(57) ABSTRACT

Methods, devices, and systems for communicating a brake pedal input to a brake without a physical connection through a firewall of a vehicle is provided. The position of the pedal is detected and electronically communicated to a control unit that causes the brake to slow the rotation of a wheel and inhibit the movement of a vehicle. In addition, the driver can select a pedal force profile to provide a preferred pedal feel for the driver. The brake system and the control unit can also compensate for additional loads in or attached to the vehicle such as a trailer. For example, the control unit cases the brake to activate with an increased force so the vehicle slows at the same rate and with the same pedal feel for the driver, even with an additional load. Further features and details are described herein.

### FIELD

The present disclosure is generally directed to systems and methods for braking a vehicle.

### BACKGROUND

A brake inhibits the movement of a vehicle to slow the vehicle or completely stop the vehicle, and a driver of the vehicle can press a pedal to activate the brake. The brake applies more braking force when the pedal is pressed with greater force. Currently, most vehicles use a series of physical connections to link the pedal to the brake. The pedal drives a rod into a brake booster, which uses a vacuum to increase the force applied by the rod. The rod presses into a master cylinder, which converts the linear motion of the rod to hydraulic pressure. Then, the increased hydraulic pressure activates the brake. Thus, these components are physically linked to each other with rods and springs or a fluid such as hydraulic fluid.

While these physical connections provide a braking system that slows or stops a vehicle, these physical connections also introduce several issues related to manufacturing and safety. For instance, the reinforcement structures needed to fix the pedal and brake booster are different for left-hand driver and right-hand driver vehicles, which increases complexity and costs. In addition, from the perspective of the driver, the feel of pressing the pedal depends mostly on the performance of the brake booster. Therefore, with additional occupants, cargo, trailers, or any other load, the feel of the brake varies. This can be a safety issue when an inexperienced driver attempts to brake since the inexperienced driver may press the pedal with a force sufficient for an empty vehicle when in reality the vehicle is towing a trailer.

Moreover, the brake system and physical connections affect the firewall. The firewall is the component that separates the engine compartment from the passenger compartment to prevent heat transfer between the compartments and also to prevent a fire from spreading from the engine compartment to the passenger compartment during an emergency. The physical connections of the brake system inherently create a gap in the firewall, and thus, reduce the performance of the firewall. In addition, the hole in the firewall can result in fluid leaks spreading from one compartment to another compartment and issues related to noise, vibration, and harshness.

### BRIEF SUMMARY

Systems, methods, and apparatuses of the present disclosure address these and other issues with previous braking systems. A braking system described herein decouples the physical connections to maintain the integrity of the firewall in a vehicle and improve the performance of the braking system. The decoupled braking system can provide a consistent pedal feel for a driver and compensate for increased loads in or attached to the vehicle.

According to one embodiment, a brake system is provided where a control unit receives and transmits electric signals so that a brake slows a wheel in response to a driver pressing a pedal. A sensor can detect how far a driver presses a pedal, and the sensor transmits this information to the control unit. Based on this input, and possibly other inputs, the control unit then directs an actuator or motor to activate the brake with a predetermined force. With at least one of the physical connections in the braking system replaced with an electronic connection, the braking system can operate without a gap in the firewall. As discussed in further detail below, the control unit can receive and/or transmit information to other control units within the vehicle to determine the force with which the actuator or motor activates the brake.

According to one embodiment, a brake system is provided where a driver experiences a consistent pedal feel. Without a continuous series of the physical connections, the pedal acts against, for example, a spring to provide a passive force as the driver presses the pedal. In addition, an electric motor can provide an active force as the driver presses the pedal. In some embodiments, the driver selects a brake mode and a pedal feel, for example, a softer feel where the driver presses the pedal further for a predetermined brake force, a stiffer feel where the driver presses the pedal a short distance for the same brake force, etc. The electric motor provides a torque that translates to a force that the driver overcomes to press the pedal. This active force can align with the passive force, act against the passive force, or not act at all. Further still, in some embodiments, the pedal feel is provided exclusively by the electric motor and the active force, and the braking system does not have a biasing assembly or a passive force.

According to one embodiment, a brake system is provided where a control unit compensates for an additional load in or attached to the vehicle. The additional load can be in the form of additional occupants in the vehicle, cargo placed in or attached to the vehicle, a trailer attached to a hitch of the vehicle, etc. The driver typically presses the pedal further so that the brake applies a larger force and the vehicle stops with an increased load in the same distance as a vehicle without a load. With embodiments of the present disclosure, a control unit can receive an input for an increased load, for example, from a load sensor or an accelerometer, and then cause the brake to apply a larger force to compensate for the additional load. From the perspective of the driver, the pedal is pressed the same distance and the vehicle stops in the same distance as the vehicle would without the additional load.

These and other advantages will be apparent from the disclosure of the aspects, embodiments, and configurations contained herein.

It should be understood that every maximum numerical limitation given throughout this disclosure is deemed to include each and every lower numerical limitation as an alternative, as if such lower numerical limitations were expressly written herein. Every minimum numerical limitation given throughout this disclosure is deemed to include each and every higher numerical limitation as an alternative, as if such higher numerical limitations were expressly written herein. Every numerical range given throughout this disclosure is deemed to include each and every narrower numerical range that falls within such broader numerical range, as if such narrower numerical ranges were all expressly written herein. By way of example, the phrase from about 2 to about 4 includes the whole number and/or integer ranges from about 2 to about 3, from about 3 to about 4 and each possible range based on real (e.g., irrational and/or rational) numbers, such as from about 2.1 to about 4.9, from about 2.1 to about 3.4, and so on. Unless otherwise noted, all component or composition levels are in reference to the active portion of that component or composition and are exclusive of impurities, for example, residual solvents or by-products, which may be present in commercially available sources of such components or compositions. All percentages and ratios are calculated by total composition weight, unless indicated otherwise.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a side elevation view of a vehicle with a brake system;

FIG. 2 is a perspective view of a brake system in accordance with embodiments of the present disclosure;

FIG. 3A is a perspective view of a biasing assembly in a first state in accordance with embodiments of the present disclosure;

FIG. 3B is a perspective view of the biasing assembly in FIG. 3A in a second state in accordance with embodiments of the present disclosure;

FIG. 4 is a side elevation view of a vehicle with a brake system in accordance with embodiments of the present disclosure;

FIG. 5 is a schematic view of a system for adjusting a pedal force profile in accordance with embodiments of the present disclosure;

FIG. 6 is a control logic for a system for adjusting a pedal force profile in accordance with embodiments of the present disclosure;

FIG. 7 is a graph of a pedal position versus a pedal force in accordance with embodiments of the present disclosure;

FIG. 8 is a schematic view of a system for adjusting a brake force profile in accordance with embodiments of the present disclosure;

FIG. 9 is a control logic for a system for adjusting a brake force profile in accordance with embodiments of the present disclosure; and

FIG. 10 is a graph of a pedal position versus a brake force in accordance with embodiments of the present disclosure.

It should be understood that the diagrams are provided for example purposes only and should not be read as limiting the scope of the disclosure. Many other configurations are fully contemplated and included in the scope of the disclosure.

### DETAILED DESCRIPTION

It is with respect to the above issues and other problems that the embodiments presented herein were contemplated. In general, embodiments of the present disclosure provide methods, devices, and systems for decoupling the physical connections of a brake system. As a result, a brake mode can be selected to provide a specific pedal force for the driver that is independent of the force that is actually applied by the brake itself. In addition, the brake system can detect an increased load and increase the force applied at the brake to provide a consistent braking feel for the driver.

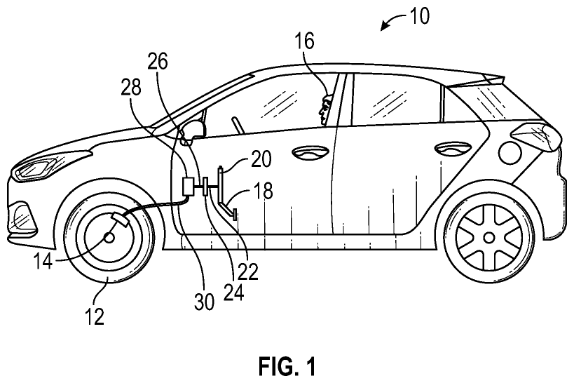

FIG. 1 is a side elevation view of a vehicle 10 with a typical brake system that has physical connections. As described above, the brake system of a vehicle 10 has a series of physical connections to active a brake 14, slow rotation of a wheel 12, and inhibit movement of the vehicle 10. A driver 16 in the vehicle 10 can press a pedal lever 18 with his or her foot to activate the brake 14. Pressing the pedal lever 18 causes the pedal lever to rotate about an axis 20 and push a first rod 22 into a brake booster 24. The first rod 22 is often the mechanical link in the brake system that extends through a firewall and causes many negative effects as described above.

The brake booster 24 is a component that amplifies the force of the first rod 22 using a vacuum from the manifold of an engine, or even a separate vacuum pump. This allows a driver to activate the brake 14 with less physical effort. After the brake booster 24, a second rod 26 drives into a master cylinder 28, which converts linear, mechanical force into hydraulic pressure. Then, a hydraulic line 30 extends from the master cylinder 28 to the brake 14, and the increased hydraulic pressure activates the brake to slow rotation of the wheel 12 and inhibit movement of the vehicle 10. It will be appreciated that this description of a brake system is exemplary in nature, and embodiments of the present disclosure encompass brake systems that have additional components, fewer components, or even different components.

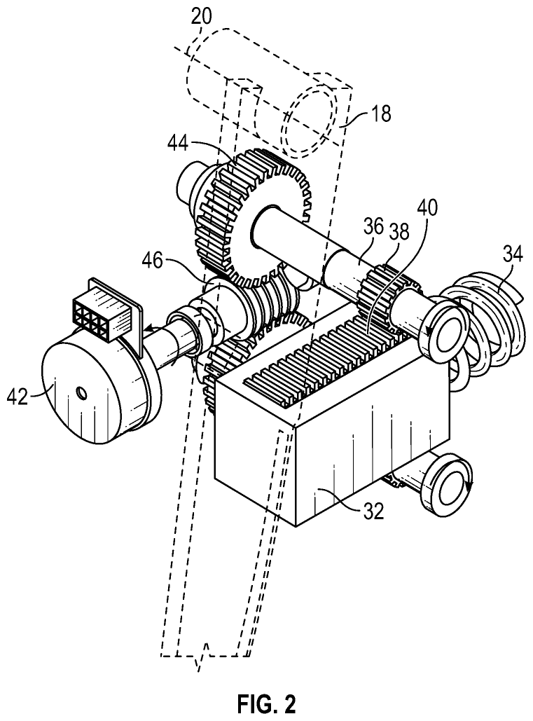

FIG. 2 is a perspective view of a brake system, specifically the pedal assembly in the passenger compartment of the vehicle. As shown, the pedal lever 18 is rotatable about an axis 20. As the pedal lever 18 rotates, the pedal lever 18 contacts a rack 32. As described in further detail below, the rack 32 moves within a housing, and a biasing assembly 34 biases the rack 32 relative to the housing. Thus, the pedal 18 moves the rack 32 in a first direction within the housing, and the biasing assembly 34 biases the rack 32 in a second direction within the housing where the second direction opposes the first direction. The biasing assembly 34 provides a passive force against the movement of the pedal lever 18 to provide increasingly resistive force as the pedal lever 18 is pressed further by the driver, and the passive force can reset the pedal lever 18 to an original position once the driver releases the pedal lever 18. Sensors that detect the position of the rack 32 within the housing and/or the angle of the pedal lever 18 about the axis 20 can provide information regarding the pedal position, i.e., the distance that the driver has pressed the pedal lever 18 from the original position of the pedal lever 18. It will be appreciated that in various embodiments, the pedal lever 18 could contact the biasing assembly 34, a rod that contacts one of the rack 32 or the biasing assembly 34, etc.

Also shown in FIG. 2 is an electric motor 42 that provides an active force against the pedal lever 18. Pedal feel is a perception of the driver when the driver presses the pedal to activate the brake. The pedal feel can be based on the pedal travel and the force exerted by the driver to inhibit the movement of the vehicle. Different pedal modes can be selected on an input device, which can be a mobile electric device with a touch screen or button, or even a device that detects audio or hand gestures. It will be appreciated that the input device can be any device that receives an input, and a plurality of pedal modes can be presented for selection, for example, a comfort mode, a sport mode, an eco mode, a soft mode, a stiff mode, etc. After a pedal mode is selected, the electric motor 42 can apply the pedal mode to the pedal lever 18. In some embodiments, as described above, the biasing assembly 34 provides a passive force that affects the pedal feel. The electric motor 42 can provide an active force that can provide an event greater force against the pedal lever 18 in the second direction or even act in the first direction against the biasing assembly 34 to apply the selected pedal mode.

The electric motor 42 is mechanically connected to the rack 32 in FIG. 2. A shaft 36 is positioned above the rack 32, and a pinion gear 38 on the shaft 36 engages a rack gear 40 on the rack 32. Therefore, a torque on the shaft 36 supplied by the electric motor 42 results in a force on the rack 32 in either the first or second direction as the rack 32 moves within the housing. The electric motor 42 is connected to the shaft 36 via another set of gears 44, 46, but it will be appreciated that the output shaft of the electric motor 42 can be directly connected to the shaft 36.

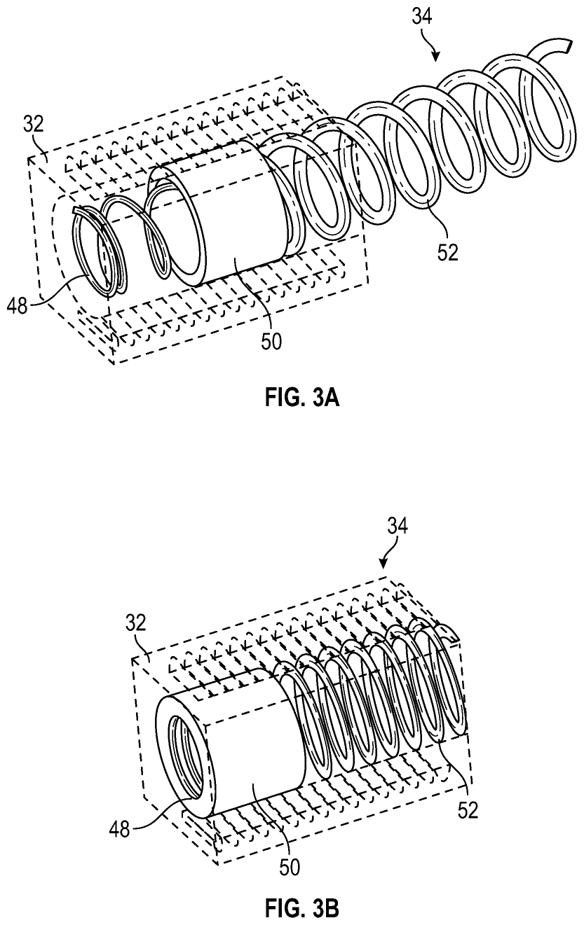

FIGS. 3A and 3B show the biasing assembly 34 in a first or uncompressed state and a second or compressed state, respectively. In this embodiment, the biasing assembly comprises a first spring 48, a second spring 52, and a stopper 50 positioned between the springs 48, 52. The springs 48, 52 can have a different spring constant and/or a different uncompressed length. As a result, the biasing assembly 34 can have provide the passive force described above in a non-linear manner. For example, the first spring 48 can be softer, and thus, compressed before the stiffer second spring 52. It will be appreciated that the biasing assembly 34 in various embodiments can be a single spring, more than two springs, and some embodiments of the disclosure can lack the biasing assembly 34 altogether.

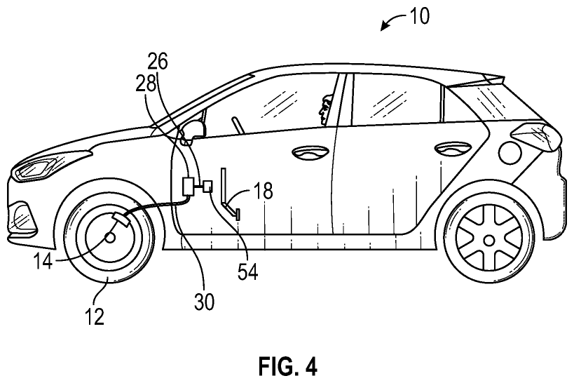

FIG. 4 is a side elevation view of a vehicle with a brake system without a continuous series of physical connections. The angle of the pedal lever 18 and/or the position of the rack within the housing can be received by a control unit, which then directs an actuator 54 to drive the second rod 26 into the master cylinder 28. The physical separation between the pedal assembly and the other components of the brake system provides a continuous firewall and eliminates the negative effects of compromising the firewall with a gap. In addition, the lack of a continuous series of physical connections also provides other benefits. An electric motor can provide a consistent pedal feel for a drive independent of other factors such as increased loads in or attached to the vehicle. The control unit can direct the actuator 54 to apply a brake force that compensates for these factors. It will be appreciated that other embodiments can have more components, fewer components, or different components. For instance, the actuator 54 may replace the rods 26, the brake booster, and even the master cylinder 28 to directly control hydraulic fluid pressure based on an input from the control unit.

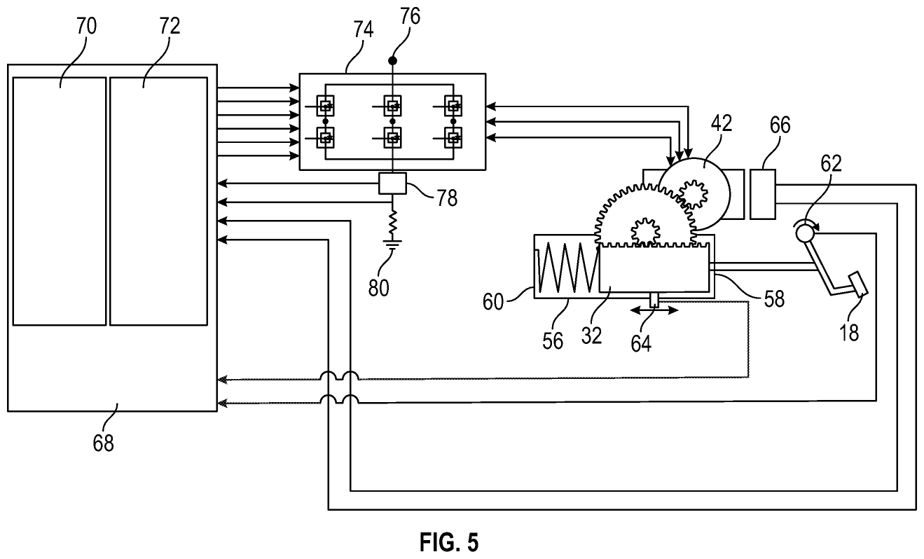

FIG. 5 is a schematic view of a system for adjusting a pedal force profile. As described above, the pedal lever 18 can move the rack 32 within a housing 56, and a position sensor 64 detects the position of the rack 32 between a first end 58 and a second end 60 of the housing 56. Similarly, an angle sensor 62 can detect the rotational position of the pedal lever 18. The detected positions are transmitted to a control unit 68. In addition, the electric motor 42 is operably connected to the rack 32 to impose a force on the rack 32 within the housing 56. Sensors 66 on the electric motor can detect, for example, the position and speed of the rotor relative to the stator of the electric motor 42, and transmit this information to the control unit 68.

In this embodiment, the control unit 68 can have a communication unit 70 that communicates with other components and/or receives additional inputs. For example, a Controller Area Network (CAN bus) is a robust vehicle bus standard designed to allow microcontrollers and devices to communicate with each other in applications without a host computer. It is a message-based protocol, designed originally for multiplex electrical wiring within automobiles to save on copper. The control unit 68 can also have a motor controller 72 that specifically control the inputs to the electric motor 42 so that the electric motor 42 produces a specific torque at a specific time.

A switch 74 is in operable communication with the motor controller 72 and the control unit 68, generally. A voltage 76 is applied to the switch 74 to provide the necessary electric input for the electric motor 42. A magnetic current sensor 78 and a current resistor sensor 80 provide additional information to the control unit 68. The switch 74 can include three pairs of power metal-oxide-semiconductor field-effect transistors (MOSFETs) arranged in a bridge structure, as shown in FIG. 5. Each pair governs the switching of one phase of the electric motor 42. The high-side MOSFETs are controlled using pulse-width modulation (PWM) which converts the input DC voltage into a modulated driving voltage. The use of PWM allows the start-up current to be limited and offers precise control over speed and torque.

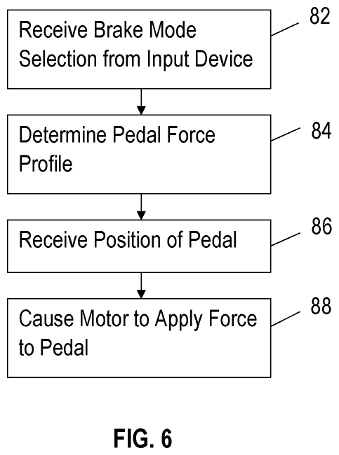

FIG. 6 is an exemplary control logic for adjusting or selecting a pedal force profile. A control unit as described herein can execute instructions causing the performance of some or all of these actions, and alternatively, some or all of these actions can be performed by another (remotely located) computer system or user. In addition, these actions may be performed simultaneously or in a different order.

To begin, a driver or other occupant of the vehicle can select a brake mode that provides a predetermined pedal feel when pressing the brake. The selection can be made using an input device in some embodiments, a voice command or a gesture in other embodiments, etc. The selection can be made among a plurality of different brake modes that provide different pedal feels, as described herein. In yet further embodiments, the plurality of brake modes can be presented in at least one order such as alphabetical, most popular, most eco-friendly, etc. The control unit then receives 82 the brake mode selection.

Once the selection is received, the control unit determines 84 a pedal force profile. Specifically, the pedal force profile is the amount of force that a driver feels at the pedal when pressing the pedal. As described herein, a biasing assembly can provide a passive force, and/or an electric motor can provide an active force. The control unit can determine the force on the pedal based on at least one input such as the position of the pedal. Then, for instance, the control unit can determine the amount of torque needed from the electric motor which generates a force that, in combination with passive force in some embodiments, provides the predetermined force felt by the driver at the pedal. Thus, during practice, the control unit can receive 86 the position of the pedal from a sensor, and then cause 88 the electric motor to supply the required torque.

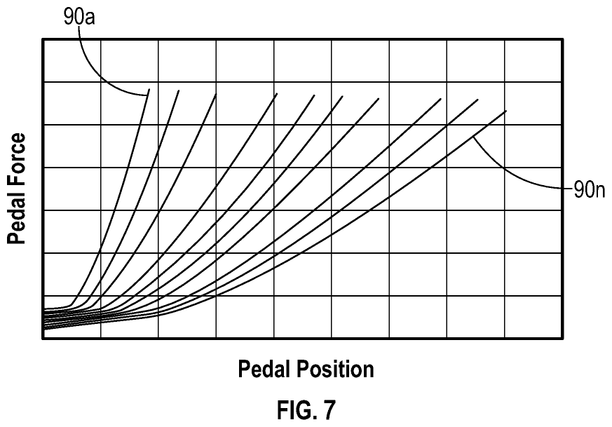

FIG. 7 is a graph that depicts the pedal position versus the pedal force. The further a driver presses the pedal, the more force is exerted by the driver to counteract the passive and active forces provided by the biasing assembly and the electric motor. The different pedal force profiles correspond to different brake modes. For instance, the first pedal force profile 90a is a stiff profile where the driver quickly reaches a high force in a short amount of pedal travel. Conversely, the last pedal force profile 90n is a softer profile where a driver presses the pedal for a long pedal travel before experiencing a higher force.

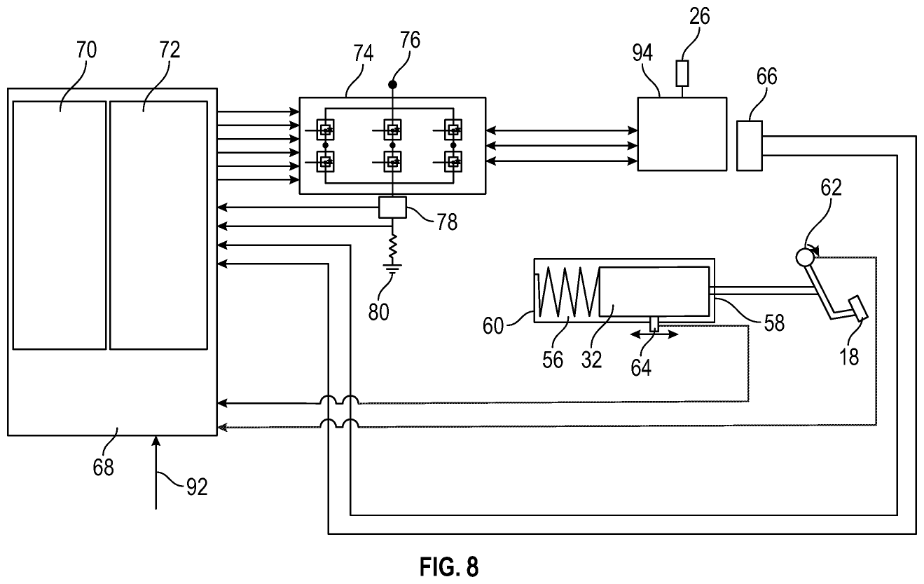

FIG. 8 is a schematic view of a system for adjusting a brake force profile. Similar to the schematic in FIG. 5, a control unit can receive readings from various sensors 62, 64, 66 regarding a position of the rack 32 within the housing 56 and information about an actuator 94. A load input 92 can be an additional reading received by the control unit 68. For example, a mass sensor or an accelerometer can detect a trailer attached to the vehicle, cargo placed in the vehicle, etc. A motor controller 72 controls the input to the actuator 94 to then drive, for example, a rod 26 into a master cylinder to activate the brake. The control unit can compensate for a load input 92 such as a trailer by causing the actuator 94 to drive the rod 26 with an increased force or brake force profile. Thus, the driver presses the pedal lever 18 with the same pedal feel, but the control unit and the brake apply a larger force to compensate for the additional load.

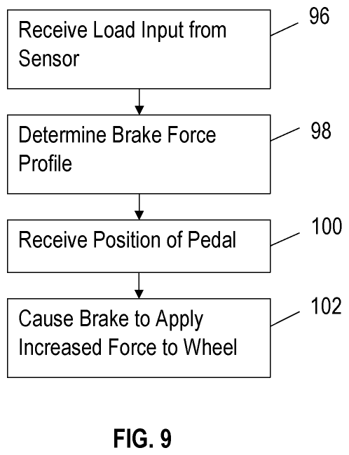

FIG. 9 is an exemplary control logic for adjusting or selecting a brake force profile. A control unit as described herein can execute instructions causing the performance of some or all of these actions, and alternatively, some or all of these actions can be performed by another (remotely located) computer system or user. In addition, these actions may be performed simultaneously or in a different order.

To begin, the control unit receives 96 a load input from a sensor. For example, a load cell can determine a load attached to a trailer hitch or other mount on the vehicle, and the load cell transmits the information to the control unit. In another example, accelerometers on board the vehicle can determine a change in the movement of the vehicle, such as acceleration of the vehicle, that corresponds to an increased load, and the accelerometers transmit the information to the control unit. It will be appreciated that the load input can be transmitted to the control unit in many different forms and from many different sensors.

With the load input information, the control unit can determine 98 a brake force profile. In some embodiments, a brake force profile is determined by modifying a default brake force profile. The default brake force profile relates inputs such as the pedal position to the force applied by the brake, which stops the vehicle. The modified brake force profile also relates inputs to an increased force by the brake to compensate for the additional load. In some embodiment, this increased force stops the vehicle in the same distance as the default brake force profile. Therefore, in practice, the control unit receives 100 the position of the pedal from a sensor, and then causes 102 the brake to apply a force in accordance with the modified brake force profile.

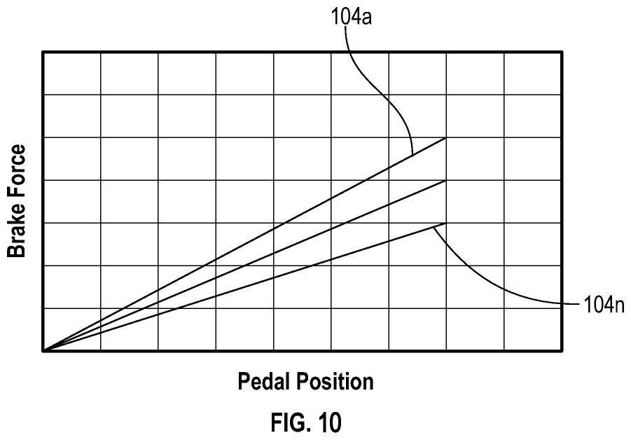

FIG. 10 is a graph that depicts the pedal position versus the brake force. The first brake force profile 104a represents a brake force that compensates for an increased load. As the driver presses the pedal, the brake is activated with a greater force. The final brake force profile 104n represents a default brake force profile that does not compensate for an increased load.

The features of the various embodiments described herein are not intended to be mutually exclusive. Instead, features and aspects of one embodiment may be combined with features or aspects of another embodiment. Additionally, the description of a particular element with respect to one embodiment may apply to the use of that particular element in another embodiment, regardless of whether the description is repeated in connection with the use of the particular element in the other embodiment.

Examples provided herein are intended to be illustrative and non-limiting. Thus, any example or set of examples provided to illustrate one or more aspects of the present disclosure should not be considered to comprise the entire set of possible embodiments of the aspect in question. Examples may be identified by the use of such language as “for example,” “such as,” “by way of example,” “e.g.,” and other language commonly understood to indicate that what follows is an example.

The systems and methods of this disclosure have been described in relation to the air curtains positioned in a vehicle. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

A number of variations and modifications of the disclosure can be used. It would be possible to provide for some features of the disclosure without providing others.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Embodiments include a brake system for a vehicle comprising, comprising: a vehicle having a mass and having a brake that inhibits movement of the vehicle; an actuator that activates the brake with a force; a pedal lever rotatable about an axis; a rack that is moveable within a housing, wherein rotation of the pedal lever about the axis moves the rack within the housing in a first direction; a biasing assembly that biases the rack relative to the housing in a second direction that opposes the first direction; a position sensor that detects a current position of the rack within the housing between first and second ends of the housing; and a control unit that receives the current position of the rack from the position sensor, and the control unit transmits an input signal to the actuator such that the actuator applies the force to the brake, wherein the force is a function of the current position of the rack within the housing.

Aspects of the above brake system can include: a mass sensor that detects an additional mass, wherein the control unit determines a modified brake force profile based on the mass of the vehicle and the additional mass, wherein the modified brake force profile is distinct from a default brake force profile based on only the mass of the vehicle, and wherein the force is a function of the current position of the rack within the housing according to the modified brake force profile; the mass sensor is at least one of a load cell or an accelerometer; an average force of the modified brake force profile is greater than an average force of the default brake force profile; the force is greater as the current position of the rack is closer to the second end of the housing; the biasing assembly has a first spring connected to the first end of the housing and having a second spring connected to the first spring and connected to the second end of the housing, wherein the first spring has a spring constant that is distinct from a spring constant of the second spring; the actuator is at least one of a DC motor or a linear actuator that drives a rod into a master cylinder with the force; a firewall with at least one continuous portion positioned between the rack and the actuator.

Embodiments also include a brake system, comprising: a control unit programmed to control a brake that inhibits movement of a vehicle having a mass; a pedal lever rotatable about an axis; a rack that is moveable within a housing, wherein rotation of the lever about the axis moves the rack within the housing; a position sensor that detects a current position of the rack within the housing between first and second ends of the housing; a mass sensor that detects an additional mass; an actuator that activates the brake with a force; and a computer readable medium comprising instructions that, when executed, cause the control unit to: receive, from the position sensor, the current position of the rack and receive, from the mass sensor, the detected additional mass; determine a modified brake force profile based on the mass of the vehicle and the additional mass; and send an input signal to the actuator such that the actuator applies the force to the brake, wherein the force is a function of the current position of the rack within the housing according to the modified brake force profile.

Aspects of the brake system also include the additional mass is at least one of an occupant, a cargo, or a trailer attached to the vehicle; a shaft operably connected to the rack, wherein a torque applied to the shaft imparts a pedal force on the rack within the housing; an electric motor operably connected to the shaft, wherein the electric motor applies the torque to the shaft, wherein the control unit is programmed to control the electric motor; and a computer readable medium comprising instructions that, when executed, cause the control unit to: receive a brake mode selection from an input device; receive, from the position sensor, the current position of the rack within the housing; determine, based on the brake mode selection, a pedal force profile; and cause the electric motor to apply the torque to the shaft and the pedal force to the rack, wherein the pedal force is a function of the current position of the rack within the housing according to the pedal force profile; the pedal force is a function of a velocity of the rack of within the housing according to the pedal force profile; the force applied to the brake is independent of the pedal force applied to the rack.

Embodiments include a system for selecting a pedal force profile for a pedal lever, comprising: a pedal lever rotatable about an axis; a rack that is moveable within a housing, wherein rotation of the pedal lever about the axis moves the rack within the housing; a position sensor that detects a current position of the rack within the housing between first and second ends of the housing; a shaft operably connected to the rack, wherein a torque applied to the shaft imparts a pedal force on the rack within the housing; an electric motor operably connected to the shaft, wherein the electric motor applies the torque to the shaft; a control unit programmed to control the electric motor; and instructions that, when executed, cause the control unit to: receive a brake mode selection from an input device and receive the current position of the rack within the housing from the position sensor; determine, based on the brake mode selection, a pedal force profile; cause the electric motor to apply the torque to the shaft and the pedal force to the rack, wherein the pedal force is a function of the current position of the rack within the housing according to the pedal force profile.

Aspects of the system include the shaft is operably connected to the rack via a pinion gear on the shaft and a rack gear on the rack, and the electric motor is operably connected to the shaft via at least one gear; the control unit receives a velocity of the rack within the housing, and the pedal force is a function of the velocity of the rack within the housing according to the pedal force profile; the brake mode is selected from a plurality of brake modes on the input device; one brake mode of the plurality of brake modes has a pedal force profile that is distinct from a pedal force profile of another brake mode of the plurality of brake modes; a vehicle having a mass and having a brake that inhibits movement of the vehicle; an actuator that activates the brake with a force according to a brake force profile, wherein the force applied to the brake is independent of the pedal force applied to the rack; rotation of the pedal lever about the axis moves the rack within the housing in a first direction, and a biasing assembly biases the rack relative to the housing in a second direction that opposes the first direction.

Any one or more of the aspects/embodiments as substantially disclosed herein optionally in combination with any one or more other aspects/embodiments as substantially disclosed herein.

One or means adapted to perform any one or more of the above aspects/embodiments as substantially disclosed herein.

The following definitions may be used in this disclosure.

“A” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

“At least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “automatic” and variations thereof refer to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” refers to any computer-readable storage and/or transmission medium that participate in providing instructions to a processor for execution. Such a computer-readable medium can be tangible, non-transitory, and non-transient and take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

A “computer readable storage medium” may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may be any computer readable medium that is not a computer readable storage medium and that can communicate, propagate, or transport a program for use by or in connection with an instruction execution system, apparatus, or device. A computer readable signal medium may convey a propagated data signal with computer readable program code embodied therein, for example, in baseband or as part of a carrier wave. Such a propagated signal may take any of a variety of forms, including, but not limited to, electro-magnetic, optical, or any suitable combination thereof. Program code embodied on a computer readable signal medium may be transmitted using any appropriate medium, including but not limited to wireless, wireline, optical fiber cable, RF, etc., or any suitable combination of the foregoing.

The terms “determine”, “calculate” and “compute,” and variations thereof, are used interchangeably and include any type of methodology, process, mathematical operation or technique.

“Means” shall be given its broadest possible interpretation in accordance with 35 U.S.C. § 112(f). Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

The term “module” refers to any known or later developed hardware, software, firmware, artificial intelligence, fuzzy logic, or combination of hardware and software that is capable of performing the functionality associated with that element.

What is claimed is:

1. A brake system for a vehicle comprising, comprising:
a vehicle having a mass and a brake that inhibits movement of the vehicle;
an actuator that activates the brake with a force;
a pedal lever rotatable about an axis;
a rack that is moveable within a housing, wherein rotation of the pedal lever about the axis moves the rack within the housing in a first direction;
a biasing assembly that biases the rack relative to the housing in a second direction that opposes the first direction;
a position sensor that detects a current position of the rack within the housing between first and second ends of the housing; and
a control unit that receives the current position of the rack from the position sensor, and the control unit transmits an input signal to the actuator such that the actuator applies the force to the brake, wherein the force is a function of the current position of the rack within the housing.

2. The brake system of claim 1, further comprising:
a mass sensor that detects an additional mass, wherein the control unit determines a modified brake force profile based on the mass of the vehicle and the additional mass, wherein the modified brake force profile is distinct from a default brake force profile based on only the mass of the vehicle, and wherein the force is a function of the current position of the rack within the housing according to the modified brake force profile.

3. The brake system of claim 2, wherein the mass sensor is at least one of a load cell or an accelerometer.

4. The brake system of claim 2, wherein an average force of the modified brake force profile is greater than an average force of the default brake force profile.

5. The brake system of claim 2, wherein the force is greater as the current position of the rack is closer to the second end of the housing.

6. The brake system of claim 1, wherein the biasing assembly has a first spring connected to the first end of the housing and having a second spring connected to the first spring and connected to the second end of the housing, wherein the first spring has a spring constant that is distinct from a spring constant of the second spring.

7. The brake system of claim 1, wherein the actuator is at least one of a DC motor or a linear actuator that drives a rod into a master cylinder with the force.

8. The brake system of claim 1, further comprising:
a firewall with at least one continuous portion positioned between the rack and the actuator.

9. A brake system, comprising:
a control unit programmed to control a brake that inhibits movement of a vehicle having a mass;
a pedal lever rotatable about an axis;
a rack that is moveable within a housing, wherein rotation of the lever about the axis moves the rack within the housing;
a position sensor that detects a current position of the rack within the housing between first and second ends of the housing;
a mass sensor that detects an additional mass;
an actuator that activates the brake with a force; and
a computer readable medium comprising instructions that, when executed, cause the control unit to:
receive, from the position sensor, the current position of the rack and, from the mass sensor, the detected additional mass;
determine a modified brake force profile based on the mass of the vehicle and the additional mass; and
send an input signal to the actuator such that the actuator applies the force to the brake, wherein the force is a function of the current position of the rack within the housing according to the modified brake force profile.

10. The brake system of claim 8, wherein the additional mass is at least one of an occupant, a cargo, or a trailer attached to the vehicle.

11. The brake system of claim 9, further comprising:
a shaft operably connected to the rack, wherein a torque applied to the shaft imparts a pedal force on the rack within the housing;
an electric motor operably connected to the shaft, wherein the electric motor applies the torque to the shaft, wherein the control unit is programmed to control the electric motor; and
a computer readable medium comprising instructions that, when executed, cause the control unit to:
receive a brake mode selection from an input device;
receive, from the position sensor, the current position of the rack within the housing;
determine, based on the brake mode selection, a pedal force profile; and
cause the electric motor to apply the torque to the shaft and the pedal force to the rack, wherein the pedal force is a function of the current position of the rack within the housing according to the pedal force profile.

12. The brake system of claim 11, wherein the pedal force is a function of a velocity of the rack of within the housing according to the pedal force profile.

13. The brake system of claim 8, wherein the force applied to the brake is independent of the pedal force applied to the rack.

14. A brake system for selecting a pedal force profile for a pedal lever, comprising:
a pedal lever rotatable about an axis;
a rack that is moveable within a housing, wherein rotation of the pedal lever about the axis moves the rack within the housing;
a position sensor that detects a current position of the rack within the housing between first and second ends of the housing;
a shaft operably connected to the rack, wherein a torque applied to the shaft imparts a pedal force on the rack within the housing;
an electric motor operably connected to the shaft, wherein the electric motor applies the torque to the shaft;
a control unit programmed to control the electric motor; and
instructions that, when executed, cause the control unit to:
receive a brake mode selection from an input device and the current position of the rack within the housing from the position sensor;
determine, based on the brake mode selection, a pedal force profile;
cause the electric motor to apply the torque to the shaft and the pedal force to the rack, wherein the pedal force is a function of the current position of the rack within the housing according to the pedal force profile.

15. The brake system of claim 14, wherein the shaft is operably connected to the rack via a pinion gear on the shaft and a rack gear on the rack, and the electric motor is operably connected to the shaft via at least one gear.

16. The brake system of claim 14, wherein the control unit receives a velocity of the rack within the housing, and the pedal force is a function of the velocity of the rack within the housing according to the pedal force profile.

17. The brake system of claim 14, wherein the brake mode is selected from a plurality of brake modes on the input device.

18. The brake system of claim 17, wherein one brake mode of the plurality of brake modes has a pedal force profile that is distinct from a pedal force profile of another brake mode of the plurality of brake modes.

19. The brake system of claim 14, further comprising:
a vehicle having a mass and having a brake that inhibits movement of the vehicle;
an actuator that activates the brake with a force according to a brake force profile, wherein the force applied to the brake is independent of the pedal force applied to the rack.

20. The brake system of claim 14, wherein rotation of the pedal lever about the axis moves the rack within the housing in a first direction, and a biasing assembly biases the rack relative to the housing in a second direction that opposes the first direction.
